(19) United States
(12) Patent Application Publication
(10) Pub. No.: US 2010/0245571 A1
(43) Pub. Date: Sep. 30, 2010

(54) Global hawk image mosaic

(75) Inventor: Douglas Robert DeVoe, Shalimar, FL (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Northrop Grumman Corporation, Los Angeles, CA (US)

(21) Appl. No.: 11/409,637

(22) Filed: Apr. 24, 2006

(51) Int. Cl. H04N 7/18

(52) U.S. Cl. 348/145; 348/E07.085

(57) ABSTRACT

A method of producing a mosaic image comprises the steps of capturing a plurality of overlapping images in a plurality of swaths, computing the relative displacement between adjacent ones of the overlapping images within the swaths, computing the relative displacement between adjacent ones of the overlapping images in adjacent ones of the swaths, and using the relative displacements to assemble the images into a composite image.

### FIELD OF THE INVENTION

This invention relates to methods for processing images, and more particularly to methods for creating a single composite image from multiple Electro-Optical (EO) and/or Infrared (IR) images collected by an Unmanned Air Vehicle (UAV).

### BACKGROUND OF THE INVENTION

One example of a UAV surveillance system collects imagery through a step-stare method in which multiple, overlapping images are collected over a contiguous area. The UAV camera has a relatively narrow field-of-view and individual images have limited utility due to the small ground area covered by a single image. Images can be combined using mosaicking methods to overcome this limitation. However, current methods of UAV mosaic processing do not produce a useful composite image. These methods are based on data from an inertial navigation system (INS) on-board the aircraft and contain errors that result in miss-registration between individual images rendering the composite image unsuitable for Intelligence, Surveillance and Reconnaissance (ISR), and accurate coordinate measurement.

There is a need for a mosaicking technique that can produce images suitable for Intelligence, Surveillance and Reconnaissance (ISR), and accurate coordinate measurement.

### SUMMARY OF THE INVENTION

This invention provides a method of producing a mosaic image comprising the steps of capturing a plurality of overlapping images in a plurality of swaths, computing the relative displacement between adjacent ones of the overlapping images within the swaths, computing the relative displacement between adjacent ones of the overlapping images in adjacent ones of the swaths, and using the relative displacements to assemble the images into a composite image.

### BRIEF DESCRIPTION OF THE DRAWINGS

FIG. 1 is a schematic representation of a system that can utilize the method of this invention.

FIG. 2 is a flow diagram that illustrates one embodiment of the method of the invention.

FIG. 3 is a diagram of the image coordinate system used to spatially combine images.

FIG. 4 is a detailed flow diagram that illustrates within-swath image correlation.

FIGS. 5 and 6 are sample images that illustrate the advantage of the invention.

### DETAILED DESCRIPTION OF THE INVENTION

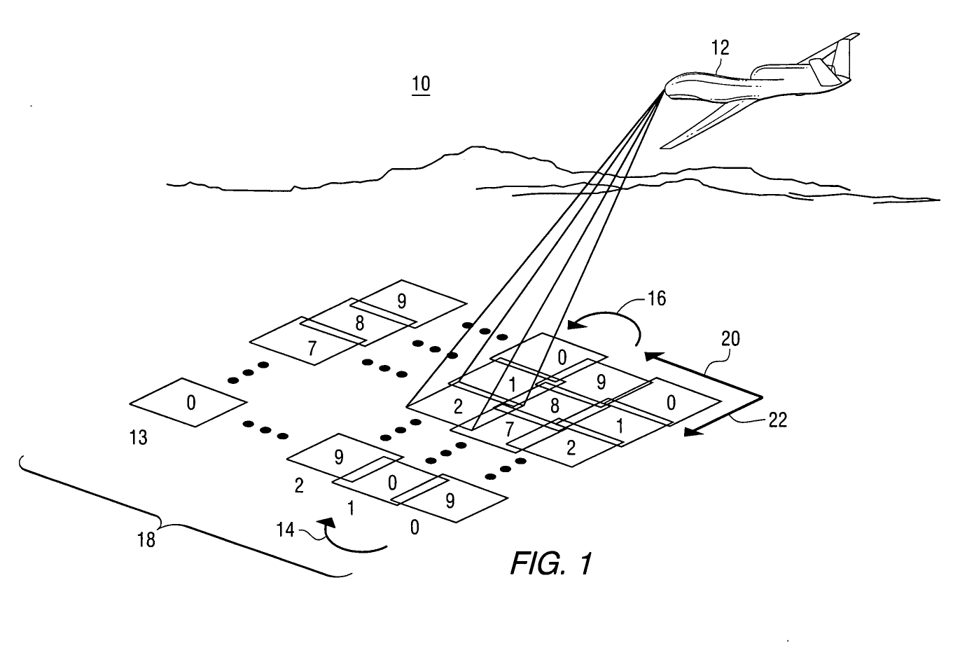

Referring to the drawings, FIG. 1 is a schematic representation of a system 10 that can be constructed and operated in accordance with one embodiment of the invention. In this example, a surveillance aircraft 12 flies over an area of interest and collects images of a scene in the area of interest. In the spot collection mode, an electro-optical (EO) system collects images of the scene in a 10×14 array, using 10 images in the cross-track direction 22, and 14 images in the along-track direction 20. If a different imaging system is used, for example an infrared (IR) system, then the aircraft might collect images of the scene in a 7×14 image array.

Images are collected using a step-stare method in a serpentine fashion as illustrated by arrows 14 and 16, first scanning away from the aircraft centerline outward along the cross-track direction, pausing for a 0.2 second turnaround time, and then scanning back towards the aircraft centerline. This process is repeated to capture a plurality of swaths of images, with the images in adjacent swaths being scanned in opposite directions. In FIG. 1, the spot images are shown as rectangles, arranged in a plurality of swaths 18 numbered 0 through 13. The number in each rectangle represents its image number in a particular swath. In the example of FIG. 1, to capture the images of swath 0, the sensor scans away from the aircraft, and to capture the images of swath 1, the sensor scans toward the aircraft.

In this example, images within a swath, scanned either away from or towards the aircraft, are collected at a rate of 30 images per second. Adjacent swaths are separated in time by 0.2 seconds. As depicted in FIG. 1, the cross-track direction is generally perpendicular to the aircraft forward velocity, and images within a swath are captured using primarily a roll gimbal. A pitch gimbal is used to a lesser extent to ensure that adjacent swaths overlap by a predetermined amount by compensating for aircraft motion.

A subtle but significant aspect of the pitch compensation is that the overlap at the near end of a swath (closest to aircraft) is generally less than the overlap at the far end of the swath. The displacements of adjacent images within a swath are generally more similar than the displacements of adjacent images across the swaths. This result makes intuitive sense considering the continuous, relatively short time between collecting images within a swath, as opposed to the 0.2 second turnaround delay and direction change between swaths. These two collection attributes form the basis upon which the mosaic algorithm described below is designed.

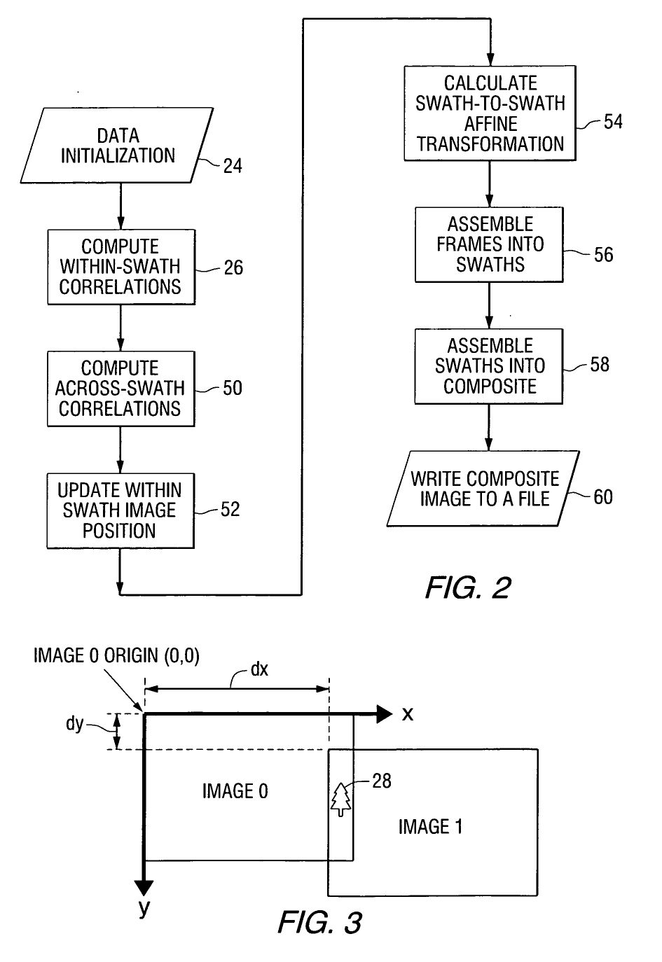

The image data can be transmitted to a computer or other processor and used to construct a mosaic of the captured images. FIG. 2 is a flowchart representation of the algorithm used by the system 10 to perform the method of this invention. Each general step in the algorithm is described in more detail below.

To begin the process, data is initialized as shown in block 24. Data initialization defines variables in the computer memory that are used in subsequent processing. In one embodiment, the specific data initialization steps are:
1. Read each image into memory along with support data describing the approximate geographic position of each image.
2. Sort images into an array so that rows of the array correspond with image collection swaths (cross-track direction) and columns correspond with image collection in the along-track direction.
3. Assign a position for each image so as to form a contiguous array. Images within a swath are positioned side-by-side; and images across the swaths are positioned top-to-bottom.

Next, within-swath correlations are computed as shown in block 26. FIG. 3 illustrates the primary quantities involved in determining the relative displacement between images. Image 1 has been displaced relative to image 0 by an amount (dx,dy) so that a feature 28 on the ground (or other scene) that is contained in both images coincides when image 1 is overlaid upon image 0.

Two processing steps are used to compute the relative displacement between overlapping images. The relative displacement is determined using image correlation. A search region (also called a search area) is defined so all possible relative displacements between two images are examined. For each relative displacement, a statistical cross correlation value is computed from the overlapping image region. The relative displacement associated with the maximum correlation value, Cₘₐₓ, over the entire search region defines the relative displacement between images.

As depicted in the example of FIG. 1, there are 140 images in a scene including 126 within-swath image overlap regions and 130 across-swath image overlap regions. The serpentine method by which UAV collects images results in similar relative image displacements for alternate numbered swaths, and thus forms a basis for how the correlations are computed.

Even-numbered swaths (0, 2, 4, 6, 8, 10, 12) are processed first, then the odd-numbered swaths (1, 3, 5, 7, 9, 11, 13) are processed. For example, the first correlation within swath 0 is between images 0 and 1, then images 1 and 2, images 2 and 3, and so on, until the correlation value for the last overlap within swath 0 (for images 8 and 9) is determined (assuming an EO scene as depicted in FIG. 1). Then, computing of within-swath correlations continues with swath 2. Correlation is computed within swath 2 between images 0 and 1, then images 1 and 2, etc. After the even-numbered swaths are processed, the algorithm computes correlations for the odd-numbered swaths in a similar fashion.

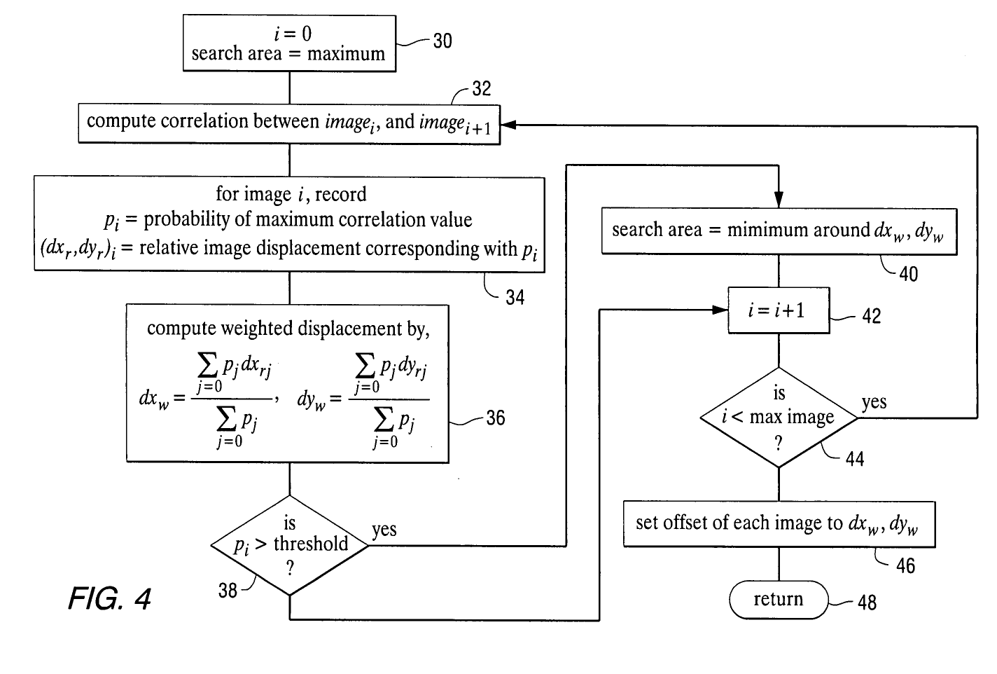

FIG. 4 is a flow diagram that illustrates the within-swath correlation subroutine. For the first image, the search area is set to a maximum value as shown in block 30. Then block 32 shows that adjacent images are correlated. For each image, i, a probability, p, of maximum correlation is computed, along with x and y relative image displacements, as shown in block 34. These values are used to compute a weighted displacement as shown in block 36. If the probability of maximum correlation is greater than a predetermined threshold value (block 38), then the search area is set to a minimum value (block 40), otherwise the image index is incremented (block 42). If the image index is less than the maximum image index (block 44), the process is repeated, otherwise the offset of each image is set (block 46), and the process returns to the initial state (block 48).

After each within-swath correlation is computed, the algorithm computes a weighted average displacement based on all the previously calculated displacements for the particular swath being processed. Weights are based on a confidence probability computed for each maximum correlation value, Cₘₐₓ. The confidence probability, p, provides an indication that the relative displacement, associated with the maximum correlation value, is accurate. Correlation is essentially a pixel-pattern matching technique, and determining the relative displacement between images possessing little or no variation in intensity is prone to error because the images correlate equally well at all relative displacements. The confidence probability provides an indication of this ambiguous condition so that the associated displacement value is given less weight in the calculation of the average displacement for the swath. The confidence probability is calculated by:
1. Find Cₘᵢₙ, the minimum correlation value.
2. Compute a threshold=0.95(Cₘₐₓ−Cₘᵢₙ).
3. Find A, the number of values in the correlation surface greater than the threshold.
4. Then p=1/A.

In addition to serving as a weight in the calculation of an average displacement, the confidence probability is also used to provide an indicator of when to narrow the search region for subsequent correlations. As depicted in FIG. 4, if p is greater than a predetermined threshold value, the search area is reduced and centered about a relative displacement indicated by the current weighted relative displacement.

Processing images in this fashion greatly reduces execution time because the search area, over which the relative displacement is expected, is significantly reduced for subsequent correlations. Moreover, processing images in this manner improves accuracy because the results between two images in which the relative displacement is well-known (high confidence) can be used to compensate for situations where the relative displacement between two images is difficult to determine using image correlation (low confidence).

Returning to FIG. 2, next the across-swath images are correlated in a similar manner (block 50). Image correlation between adjacent swaths is computed after computing the within-swath correlations. Referring again to FIG. 1, the first across-swath (also called inter-swath) correlation is between image 0 in swath 0 and image 9 in swath 1. The next correlation would be between image 1 in swath 0, and image 8 in swath 1. After the inter-swath correlations are computed for swaths 0 and 1, the algorithm computes correlations for swath 2, 4, 6, 8, 10 and 12 (with images in the adjacent higher-numbered swath). Inter-swath correlations are computed in a similar manner for swaths 1, 3, 5, 7, 9 and 11 (with images in the adjacent higher-numbered swath). Swath 13 is not processed since it is the last swath in the array. The flowchart in FIG. 4 is still pertinent for inter-swath correlation, except that images in adjacent swaths are used instead of adjacent images within a swath. In this case, block 32 in FIG. 4 would read “compute correlation between image, of swath s and image₉₋ᵢ of swath s+l” for across-swath correlations.

After the within-swath correlations are computed (block 26), the positions, or origins, of images within the swath are redefined based on the average weighted relative displacement computed for the swath (block 52). Since the correlation determines the relative displacement, i.e., a two-dimensional shift, (dx,dy), of an image with respect to it's predecessor image, the position of the first image in each swath remains unchanged. Each subsequent image is offset by a constant amount in both horizontal and vertical dimensions. The origin of the second image is redefined with respect to the first image, the origin of the third image is redefined with respect to the second image, and so on. For example, in swath 0, the origin of image 1 is redefined to be the sum of the origin of image 0, plus the two-dimensional shift determined by the average weighted relative displacement.

At this point in the process, each image's position is defined relative to the first image in each respective swath. Next, the swath-to-swath affine transformation is calculated (block 54). This processing step computes an affine transformation for each swath that relates the relative position of pixels in a swath to the preceding swath, accounting for the across-swath displacements determined via correlation. Least Squares Regression is used to determine the coefficients a, b, c, d in the expressions:

xᵢ+dx=axᵢ₊₁+byᵢ₊₁+c (1)

yᵢ+dy=−bxᵢ₊₁+ayᵢ₊₁+d (2)

where,
a=k Cos (θ)
b=k Sin (θ)
k=scale factor
θ=angle
c=x offset
d=y offset
(xᵢ, yᵢ)=pixel position in swath i
(dx, dy)=relative displacement between swath i and swath i+1.

Separate affine transforms in the form of Equations (1) and (2) are calculated to relate the position of pixels in swath 1 to the position of pixels in swath 0, swath 2 to swath 1, swath 3 to swath 2, and so on until the last swath-to-swath correlation which relates pixels in swath 13 to pixels in swath 12. Each transform slightly adjusts the size (scale factor), the orientation (angle rotation about a vertical axis), and the position (x, y offset) of a swath so as to match the preceding swath. The first swath is taken as a reference swath, although the method could be implemented to use any swath as a reference, such as the center swath.

The next step (block 56) assembles images in each swath into a single swath image by copying pixel data from each individual image to a temporary swath image that has been created in the computer's memory. Each image is displaced by the weighted relative displacement computed for the particular swath. The process first examines the total horizontal and vertical extent of the resulting swath, and allocates computer memory accordingly. A commonly used intensity feathering technique can be used to provide smooth transitions in pixel intensity in the image overlap region.

Then the swaths are assembled into a composite image (block 58). This step forms the final composite image by copying pixel data from each individual swath image to a composite image. Each swath image is magnified (or reduced) in size, rotated and translated according to the affine transform computed for that particular swath. This processing step involves the use of commonly used image resampling schemes to resize and rotate each swath image prior to copying the resampled image into a composite image created in the computer's memory. As with the previous step, the total horizontal and vertical extent of the composite image is determined, and computer memory is allocated accordingly.

The final step (block 60) writes the composite image back out to a disk. Alternatively, the image can be made available for direct exploitation in the computer memory.

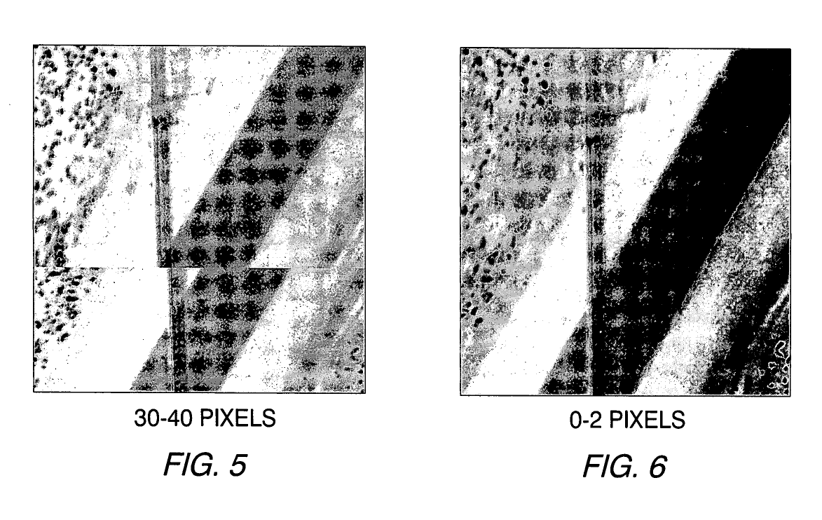

Due to inaccuracies in support data, miss-registration of adjacent images can sometimes be as large as 30-40 pixels. The mosaic algorithm corrects this problem and in general, produces a seamless composite image. FIGS. 5 and 6 depict typical results for images processed both with (FIG. 6) and without (FIG. 5) the mosaic algorithm.

The method of this invention can be performed using apparatus including known electro-optical and/or infrared sensors or cameras. The sensors are mounted using a gimbal assembly in an aircraft and possess a narrow field-of-view. The sensors can be coupled by a communications link to a computer or other processor that performs the image processing required to mosaic the sub-images.

While the invention has been described in terms of several embodiments, it will be apparent to those skilled in the art that various changes can be made to the described embodiments without departing from the scope of the invention as set forth in the following claims.

1. A method comprising the steps of:
using a sensor to capture a plurality of overlapping images in a plurality of adjacent swaths; and
using a processor to compute the relative displacement between adjacent ones of the overlapping images within the swaths, to compute the relative displacement between adjacent ones of the overlapping images in adjacent ones of the swaths, and to assemble the images into a composite image using the relative displacements.

2. The method of claim 1, wherein the step of using a sensor to capture a plurality of overlapping images in a plurality of swaths comprises the steps of:
reading each overlapping image into a memory along with support data describing an approximate geographic position of each image;
sorting the images into an array so that rows of the array correspond with image collection swaths, and columns correspond with the along-track direction; and
assigning a position for each image to form a contiguous array.

3. The method of claim 1, wherein the step of using a processor to compute the relative displacement between adjacent ones of the overlapping images within the swaths comprises the steps of:
computing a cross correlation between a search area in the adjacent images in one of the swaths; and
using a maximum cross correlation value to define the relative displacement.

4. The method of claim 3, further comprising the steps of:
determining a probability of the maximum cross correlation; and
weighting the relative displacement for adjacent ones of the images in one of the swaths by the probability of the maximum cross correlation value.

5. The method of claim 4, further comprising the step of:
creating a weighted average displacement for the images in each swath.

6. The method of claim 5, further comprising the step of:
using the weighted average displacement to update positions of the images within the swaths.

7. The method of claim 4, further comprising the steps of:
comparing the probability of the maximum cross correlation value to a threshold; and
if the probability of the maximum cross correlation value is greater than the threshold, reducing the size of the search area.

8. The method of claim 3, wherein the step of using a processor to compute the relative displacement between adjacent ones of the overlapping images between adjacent ones of the swaths comprises the steps of:
computing a cross correlation between adjacent ones of the images in adjacent ones of the swaths; and
using a maximum cross correlation to define the relative displacement.

9. The method of claim 8, further comprising the steps of:
determining a probability of the maximum cross correlation value; and
weighting the relative displacement for the adjacent ones of the images in adjacent ones of the swaths by the probability of the maximum cross correlation value.

10. The method of claim 9, further comprising the step of:
using the weighted average displacement to update positions of the images within the swaths.

11. The method of claim 10, further comprising the step of:
calculating swath-to-swath affine transformations to relate the position of pixels in one of the swaths to the position of pixels in an adjacent one of the swaths.

12. The method of claim 11, wherein the step of using a processor to assemble the images into a composite image using the relative displacements comprises the step of:
copying pixel data from the images to a memory.

13. The method of claim 1, wherein the images are captured using a step-stare process.

14. The method of claim 1, wherein the images are captured in a serpentine fashion.

15. The method of claim 2, wherein the step of using a processor to compute the relative displacement between adjacent ones of the overlapping images within the swaths comprises the steps of:
computing a cross correlation between a search area in the adjacent images in one of the swaths; and
using a maximum cross correlation value to define the relative displacement.

16. The method of claim 15, further comprising the steps of:
determining a probability of the maximum cross correlation; and
weighting the relative displacement for adjacent ones of the images in one of the swaths by the probability of the maximum cross correlation value.

17. The method of claim 16, further comprising the step of:
creating a weighted average displacement for the images in each swath; and
using the weighted average displacement to update positions of the images within the swaths.

18. The method of claim 16, further comprising the steps of:
comparing the probability of the maximum cross correlation value to a threshold; and
if the probability of the maximum cross correlation value is greater than the threshold, reducing the size of the search area.

19. The method of claim 2, wherein the step of using a processor to compute the relative displacement between adjacent ones of the overlapping images between adjacent ones of the swaths comprises the steps of:
computing a cross correlation between adjacent ones of the images in adjacent ones of the swaths; and
using a maximum cross correlation to define the relative displacement.

20. The method of claim 19, further comprising the step of:
calculating swath-to-swath affine transformations to relate the position of pixels in one of the swaths to the position of pixels in an adjacent one of the swaths.
